(19) United States
(12) Patent Application Publication
(10) Pub. No.: US 2004/0208109 A1
(43) Pub. Date: Oct. 21, 2004

(54) Objective optical system for correcting aberration and optical head employing the same

(75) Inventors: Mee-suk Jung, Suwon-si (KR); Myung-bok Lee, Suwon-si (KR); Jin-seung Son, Seoul (KR); Eun-hyoung Cho, Seoul (KR); Young-pil Park, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/828,185

(22) Filed: Apr. 21, 2004

(30) Foreign Application Priority Data
Apr. 21, 2003 (KR) 2003-25083

(51) Int. Cl. G11B 7/135

(52) U.S. Cl. 369/112.03; 369/112.26; 369/112.07; 369/112.08

(57) ABSTRACT

An objective optical system for aberration correction and an optical head adopting the objective optical system are provided. The objective optical system includes a diffraction lens and a refractive lens. The diffraction lens converges incident light and corrects aberration. The refractive lens focuses light transmitted by the diffraction lens on an optical disk. Contamination and damage of the diffraction lens are prevented, and light receiving efficiency is improved.

### BACKGROUND OF THE INVENTION

This application claims the priority of Korean Patent Application No. 2003-25083, filed on Apr. 21, 2003, in the Korean Intellectual Property Office, the disclosure of which is incorporated herein in its entirety by reference.

1. Field of the Invention

The present invention relates to an objective optical system and an optical head employing the objective optical system, and more particularly, to an objective optical system for correcting aberration and an optical head employing the objective optical system.

2. Description of the Related Art

As demand for high-capacity optical storage media increases, research into a lens capable of reducing an optical spot size LF is increasing to obtain a high-density optical disk. When the wavelength of light is indicated by λ, and the numerical aperture of an objective lens is indicated by NA, the optical spot size LF is given as Equation 1:

$$LF ≅ \frac{λ}{N A} .$$

According to Equation 1, the LF can be reduced by decreasing the light wavelength (λ) and increasing the NA.

To diminish the optical spot size LF, recently, a short wavelength light source such as a blue laser diode is used for an optical head. Also, an optical head having two objective lenses that are piled one on another, as disclosed in Japanese Patent Publication No. Hei 11-195229, is used in order to increase NA. However, in the optical head disclosed in Japanese Patent Publication No. Hei 11-195229, since the working distance between an objective lens and an optical disk is short, it is possible that the objective lens will collide with the optical disk and thus may damage the optical disk when a focusing servo departs from the range of the working distance during a recording or reproducing operation. Also, the allowance of the interval or eccentricity between two objective lenses is strict, and it is not easy to control the interval or eccentricity between them.

To solve this problem, an optical head generally uses a single objective lens instead of two objective lenses. In the optical head, a diffraction grating is installed on a light path in front of the objective lens, and an optical disk is installed on a light path behind the objective lens. However, when an objective lens with large NA is used, eccentricity between both sides of the objective lens or an error in the interval therebetween increases. Hence, several types of aberration including spherical aberration and comma aberration are enlarged. To reduce the aberration that is enlarged by the increase in NA, an additional optical system has been used in conventional optical heads. However, the additional optical system increases the volume of the optical head and hinders recording and reproduction of data to and from a small optical disk.

### SUMMARY OF THE INVENTION

To solve this problem, the present invention provides an objective optical system which can reduce color aberration and be easily manufactured, and an optical head including the objective optical system.

According to an aspect of the present invention, there is provided an objective optical system including a diffraction lens converging incident light and correcting aberration, and a refractive lens focusing light transmitted by the diffraction lens on an optical disk.

According to another aspect of the present invention, there is provided an optical head including: an illumination optical system emitting light; an objective optical system focusing the light emitted from the illumination optical system on an optical disk; and a light-receiving optical system receiving light reflected by the optical disk and detecting information from the received light. The objective optical system includes a diffraction lens converging incident light and correcting aberration, and a refractive lens focusing light transmitted by the diffraction lens on an optical disk.

The diffraction lens may have an exit side facing the refractive lens and an entrance side opposite to the exit side. The side other than the side to which a Fresnel lens has been attached may be flat, spherical or aspherical.

The diffraction lens may be combined with a diffraction grating which diffracts the light reflected by the optical disk so as to have a predetermined diffraction angle and advances the diffracted light toward the light-receiving optical system.

The refractive lens may have an exit side facing the optical disk and an entrance side facing the diffraction lens.

The exit side of the refractive lens may be flat and the entrance side of the refractive lens may be convex aspherical. Alternatively, the exit side of the refractive lens may be convex spherical and the entrance side of the refractive lens may be convex aspherical.

An objective optical system according to the present invention has a diffraction lens, such as a holographic optical element (HOE) for correcting color aberration, which does not directly face an optical disk. Thus, the objective optical system is prevented from being contaminated with particles (e.g., dust) scattering due to a fast rotation of the optical disk. Also, because the incidence angle of light incident upon the diffraction optical element for aberration correction is smaller than that of conventional objective optical systems, the amount of light advancing to a photodetector increases. Thus, light receiving efficiency can be improved.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B are a schematic cross-sectional view of and a schematic perspective view, respectively, of an objective optical system according to a first embodiment of the present invention;

FIG. 2 is a schematic cross-section of an objective optical system according to a second embodiment of the present invention;

FIG. 3 is a schematic cross-section of an objective optical system according to a third embodiment of the present invention;

FIG. 4 is a schematic cross-section of an objective optical system according to a fourth embodiment of the present invention;

FIG. 5 is a schematic configuration view of an optical head according to an embodiment of the present invention;

FIG. 6A is a schematic cross-section of an objective optical system according to a fifth embodiment of the present invention; and

FIG. 6B is a schematic configuration view of an optical head using the objective optical system according to the fifth embodiment of the present invention.

### DETAILED DESCRIPTION OF THE INVENTION

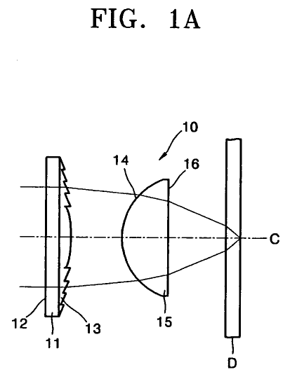

Referring to FIGS. 1A and 1B, an objective optical system 10 according to a first embodiment of the present invention includes a diffraction lens 13 and a refractive lens 15. The diffraction lens 13 corrects the color aberration of incident light and focuses light on the refractive lens 15. The refractive lens 15 focuses incident light on an optical disk D. The diffraction lens 13 is attached to a substrate 11 having a predetermined thickness.

The diffraction lens 13 is usually formed as a Fresnel lens type holographic optical element (HOE). Intervals between pitches formed on the diffraction lens 13 are adequately controlled to correct color aberration. The color aberration denotes a physical phenomenon that the location and size of an image vary due to a variation in the refractive index of an optical element according to the wavelength of light.

The refractive lens 15 focuses the light beams passed through the diffraction lens 13 on the optical disk D. The refractive lens 15 can be substituted by either a Gradient Index (GRIN) lens or a hybrid of a refractive lens and a GRIN lens. The GRIN lens has a refractive index that varies in its axial and/or radial direction. The refractive lens 15 of FIGS. 1A and 1B has an entrance side 14, which faces the diffraction lens 13 and is aspherical, and an exit side 16, which faces the optical disk D and is flat.

Light is emitted from the light source. Next, the color aberration of the emitted light is corrected by the diffraction lens 13. Then, the diffracted light from which color aberration has been removed is refracted by the refractive lens 15, and the resulting refracted light is focused on the optical disk D. A blue laser diode for emitting a blue laser beam with a wavelength band of 400-415 nm is suitable for the light source. Preferably, a lens with NA of 0.85 or greater is used as the refractive lens 15 so as to converge a blue laser beam.

The light focused on the optical disk D is reflected thereby and travels along a path reverse to the travel path of the light emitted from the light source. In other words, the light reflected by the optical disk D is re-incident upon the refractive lens 15 and passes through the diffraction lens 13. Thereafter, light separated by a diffraction grating (not shown) advances toward a photodetector (not shown). In a conventional objective optical system, a diffraction pattern for aberration correction is formed on a surface of an objective lens that directly faces an optical disk. Hence, light reflected by the optical disk is incident upon the diffraction pattern at a wide angle, and a large amount of light directs to the outside of the objective optical system. Accordingly, a light loss of the conventional objective optical system is large. However, in the objective optical system according to the first embodiment of the present invention, the light reflected by the optical disk 10 is first refracted by the refractive lens 15 and then incident upon the diffraction lens 13. Hence, the refracted light is incident upon the diffraction lens 13 at a narrowed angle, which increases the amount of light received by the photodetector. Thus, light receiving efficiency is improved.

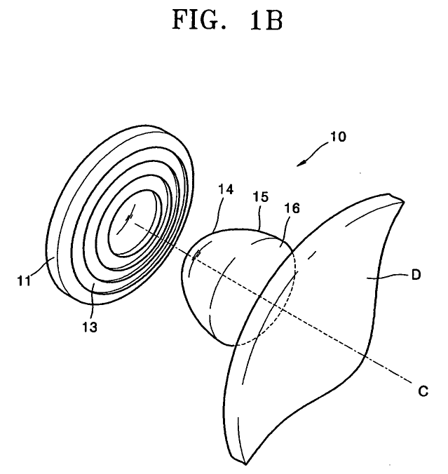

FIG. 2 is a schematic cross-section of an objective optical system 20 according to a second embodiment of the present invention. In contrast with the refractive lens 15 of FIGS. 1A and 1B, a refractive lens 25 of the objective optical system 20 of FIG. 2 has a spherical exit surface 26, which faces the optical disk D. Reference numeral 21 denotes a substrate, reference numeral 23 denotes a diffraction lens, and reference numeral 24 denotes an entrance side of the refractive lens 15. The functions of optical members in the second embodiment of the present invention and the path of light passing through the optical members are the same as described in FIGS. 1A and 1B.

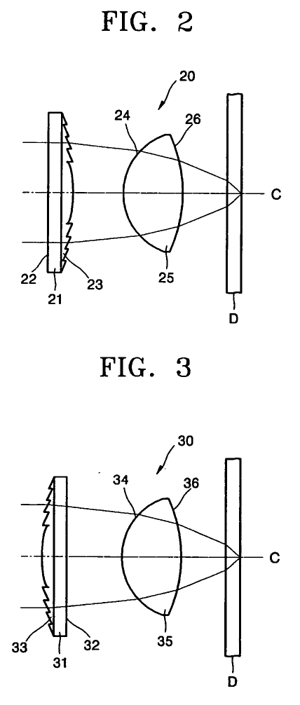

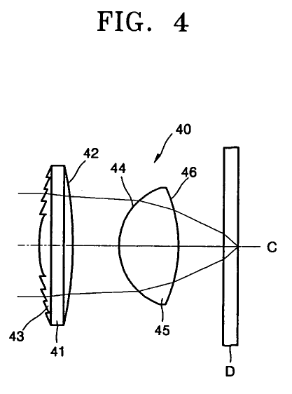

FIG. 3 is a schematic cross-section of an objective optical system 30 according to a third embodiment of the present invention. FIG. 4 is a schematic cross-section of an objective optical system 40 according to a fourth embodiment of the present invention.

In contrast with the objective optical systems 10 and 20 according to the first and second embodiments of the present invention, the objective optical system 30 of FIG. 3 has a diffraction lens 33, which is attached to the entrance side of a substrate 31. In the objective optical system 30, an exit side 32 of the substrate 31 is flat. Reference numeral 35 denotes a refractive lens, reference numerical 34 denotes an entrance side of the refractive lens 35, and reference numeral 36 denotes an exit side of the refractive lens 35.

Referring to FIG. 4, the objective optical system 40 is the same as the objective optical system 30 except that if a substrate 41 is formed of a material with a small refractive index, an exit side 42 is spherical or aspherical so as to more effectively converge light.

Of course, in the second, third, and fourth embodiments of the present invention, the exit sides 26, 36, and 46 of the refractive lenses 25, 35, and 45 may be flat. In the first and second embodiments of the present invention, entrance sides 12 and 22 of the substrates 11 and 21 may be spherical or aspherical.

A conventional hybrid-type objective optical system is typically a single objective lens having both a refraction portion and a diffraction portion. A diffractive optical element for correcting aberration is formed on a side of the single objective lens that directly faces an optical disk. Accordingly, the interval between the objective lens and the optical disk is so narrow, for example, about 0.1 to 0.2 mm, that the objective lens is prone to be damaged due to friction with air or slight contact with the disk.

However, in the objective optical systems according to the first through fourth embodiments of the present invention, the diffraction lenses 13, 23, 33, and 43 do not directly face a rotating side of the optical disk D, so that contamination or damage of the objective optical system due to particles scattering by a fast rotation of the optical disk D can be minimized. Also, because the diffraction lenses 13, 23, 33, and 43 are separately formed from the refractive lenses 15, 25, 35, and 45, respectively, the objective optical systems according to the first through fourth embodiments of the present invention can be easily manufactured and can correct color aberration while keeping the size of a conventional objective optical system.

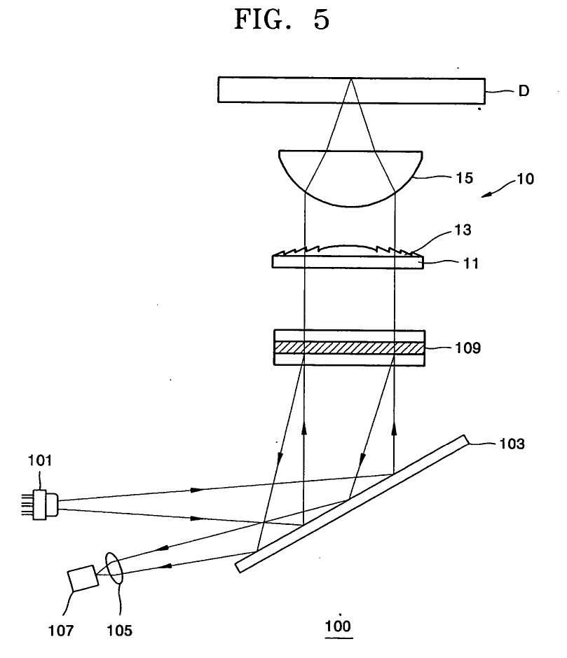

The objective optical systems according to the first through fourth embodiments of the present invention are suitable to obtain an integrated optical head. FIG. 5 is a schematic configuration view of an optical head 100 according to an embodiment of the present invention.

Referring to FIG. 5, the optical head 100 includes a light source 101, the objective optical system 10, a photodetector 107, a diffraction grating 109, and a light path converter 103 (which is a reflective mirror). The objective optical system 10 focuses light emitted from the light source 101 on an optical disk D. The photodetector 107 receives light reflected by the optical disk D and detects information from the received light. The diffraction grating 109 advances the light emitted from the light source 101 toward the objective optical system 10 and diffracts the light reflected by the optical disk so as to have a predetermined diffraction angle such that the light advances toward the photodetector 107.

The objective optical system 10 may be substituted by any of the objective optical systems 20, 30, and 40.

The light source 101 is a component of an illumination optical system. A collimating lens or a relay lens may be further installed in front of the light source 101 in order to collimate light incident on the objective optical system 10 or to equalize light intensity.

A light-receiving optical system for receiving light from the objective optical system 10 includes the diffraction grating 109, the light path converter 103, a focusing lens 105, and the photodetector 107. A binary type holographic optical element (HOE) pattern is formed on a surface of the diffraction grating 109. Light advancing toward the optical disk D passes through the diffraction grating 109 without diffraction. On the other hand, light reflected by the optical disk D and advancing in the direction reverse to the aforementioned direction is diffracted by the diffraction grating 109 at a predetermined angle. In other words, the diffraction grating 109 is a polarization diffraction grating. Hence, as shown in FIG. 5, light reflected by the light path converter 103 advances toward the photodetector 107 instead of toward the light source 101.

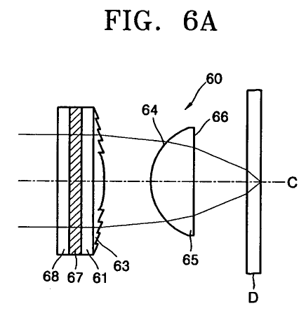

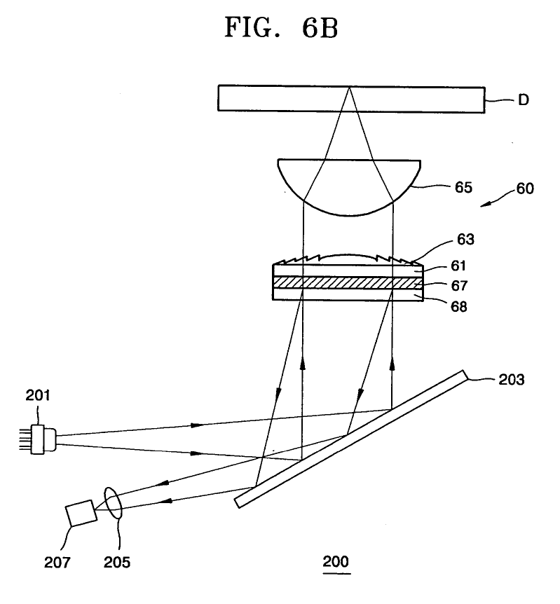

The diffraction grating 109 may be incorporated into an objective optical system so that an optical head is simplified and made compact. FIG. 6A is a schematic cross-section of an objective optical system according to a fifth embodiment of the present invention. The objective optical system according to the fifth embodiment of the present invention is basically the same as that according to the first embodiment except that a diffraction grating 67, which is a binary type HOE pattern, is attached to an entrance side of a substrate 61 and that a coating layer 68 for protecting the diffraction grating 67 is formed on a surface of the diffraction grating 67. Hence, in the fifth embodiment as shown in FIG. 5, there is no need to separately install an objective optical system and a diffraction grating. Although the diffraction grating 67 is formed on the entrance side of the substrate 61 and a diffraction lens 63 is formed on an exit side thereof in FIG. 6A, the locations of the diffraction grating 67 and the diffraction lens 63 may be exchanged. The incorporation of a diffraction grating into a diffraction lens may be equally applied to the objective optical systems according to the second through fourth embodiments.

FIG. 6B is a schematic configuration view of an optical head 200 using the objective optical system according to the fifth embodiment of the present invention. Compared with the optical head 100 of FIG. 5, the optical head 200 uses an objective optical system into which a diffraction grating is incorporated. Accordingly, the optical head 200 can be simply and compactly manufactured while maintaining the operational principle and performance of the optical head 100 of FIG. 5.

In an objective optical system according to the present invention and an optical head adopting the objective optical system, a diffractive optical member for aberration correction is distanced far from a surface of an optical disk so that it can be minimally contaminated with particles scattering due to a fast rotation of the optical disk and minimally damaged due to fraction or contact with air. Also, because the incidence angle of light incident upon the diffraction element for aberration correction is smaller than that in conventional objective optical systems, the amount of light received by a photodetector increases. Thus, light receiving efficiency can be improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An objective optical system comprising:
a diffraction lens converging incident light and correcting aberration; and
a refractive lens focusing light transmitted by the diffraction lens on an optical disk.

2. The objective optical system of claim 1, wherein a Fresnel lens is attached to one of two sides of the diffraction lens, and the other side is flat.

3. The objective optical system of claim 1, wherein a Fresnel lens is attached to one of two sides of the diffraction lens, and the other side is spherical.

4. The objective optical system of claim 1, wherein a Fresnel lens is attached to one of two sides of the diffraction lens, and the other side is aspherical.

5. The objective optical system of claim 2, wherein the side of the diffraction lens to which the Fresnel lens is attached is an entrance side on which light emitted by a light source is incident.

6. The objective optical system of claim 2, wherein the side of the diffraction lens to which the Fresnel lens is attached is an exit side from which light from which light emitted by a light source exits.

7. The objective optical system of claim 3, wherein the side of the diffraction lens to which the Fresnel lens is attached is an entrance side on which light emitted by a light source is incident.

8. The objective optical system of claim 1, wherein the diffraction lens is combined with a diffraction grating which diffracts light reflected by the optical disk so as to have a predetermined diffraction angle.

9. The objective optical system of claim 1, wherein the refractive lens has two sides, one of the two sides facing the optical disk and being flat and the other of the two sides being convex aspherical.

10. The objective optical system of claim 1, wherein the refractive lens has two sides, one of the two sides facing the optical disk and being convex spherical and the other of the two sides being convex aspherical.

11. An optical head comprising:
an illumination optical system emitting light;
an objective optical system focusing the light emitted from the illumination optical system on an optical disk; and
a light-receiving optical system receiving light reflected by the optical disk and detecting information from the received light,
wherein the objective optical system comprises:
a diffraction lens converging incident light and correcting aberration; and
a refractive lens focusing light transmitted by the diffraction lens on an optical disk.

12. The optical head of claim 11, wherein a Fresnel lens is attached to one of two sides of the diffraction lens, and the other side is flat, spherical, or aspherical.

13. The optical head of claim 11, wherein the diffraction lens is combined with a diffraction grating which diffracts the light reflected by the optical disk so as to have a predetermined diffraction angle.

14. The optical head of claim 11, wherein the refractive lens has two sides, with one of the two sides facing the optical disk and being flat and the other of the two sides being convex aspherical.

15. The optical head of claim 11, wherein the refractive lens has two sides, one of the two sides facing the optical disk and being convex spherical and the other of the two sides being convex aspherical.
